(19) United States
(12) Patent Application Publication
(10) Pub. No.: US 2024/0314807 A1
(43) Pub. Date: Sep. 19, 2024

(54) PANEL SWITCHING INDICATION IN MULTIPLE TRANSMISSION/RECEPTION POINT (MULTI-TRP) OPERATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/575,745

(22) PCT Filed: Aug. 27, 2021
(86) PCT No.: PCT/CN2021/114946

§ 371 Date: Dec. 29, 2023

(51) Int. Cl. H04W 72/232; H04B 7/08; H04L 5/00

(52) U.S. Cl. CPC H04W 72/232; H04B 7/0862; H04L 5/0046

(57) ABSTRACT

Certain aspects of the present disclosure provide techniques for configuring user equipment (UE) beam switching in multiple transmission/reception points (multi-TRPs) communications. In particular, the present disclosure provides techniques for harmonizing downlink panel switching and uplink panel switching using transmission configuration indicator (TCI) codepoints, such that in some cases, a single downlink control information (DCI) may convey multiple TCI states for multiple panels or multi-TRPs. For example, a UE receives a first DCI indicating a first TCI codepoint from TCI codepoints activated by a media access control (MAC) control element (CE). The UE receives a second DCI scheduling an uplink transmission from the UE or a downlink transmission to the UE and conveying panel switching information. The UE processes the scheduled uplink transmission and/or downlink transmission based on one or more (joint) TCI states mapped to the first TCI codepoint and the panel switching information (e.g., dynamic switching bits).

### INTRODUCTION

Aspects of the present disclosure relate to wireless communications, and more particularly, to techniques for configuring user equipment (UE) beam switching in multiple transmission/reception point (multi-TRP) communications.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications by a user equipment (UE). The method includes receiving media access control (MAC) control element (CE) signaling activating one or more transmission configuration indicator (TCI) codepoints. Each of the TCI codepoints maps to one or more TCI states configured for the UE. Each of the TCI states is separately applicable to an uplink transmission or a downlink transmission or jointly applicable to both uplink and downlink transmissions. The method further includes receiving a first downlink control information (DCI) indicating a first TCI codepoint from the activated TCI codepoints. The method includes receiving a second DCI scheduling an uplink transmission from the UE or a downlink transmission to the UE, the second DCI conveying panel switching information to the UE. The method further includes processing the scheduled uplink transmission or downlink transmission based on one or more TCI states mapped to the first TCI codepoint and the panel switching information.

One aspect provides a method for wireless communications by a network entity. The method includes transmitting, to a UE, MAC CE signaling activating one or more TCI codepoints configured therein. Each of the TCI codepoints maps to one or more TCI states configured for the UE. Each of the TCI states is separately applicable to an uplink transmission or a downlink transmission or jointly applicable to both uplink and downlink transmissions. The method further includes transmitting, to the UE, a first DCI indicating a first TCI codepoint from the activated TCI codepoints. The method includes transmitting, to the UE, a second DCI scheduling an uplink transmission from the UE or a downlink transmission to the UE, the second DCI conveying panel switching information to the UE. The method further includes processing the scheduled uplink transmission or downlink transmission based on one or more TCI states mapped to the first TCI codepoint and the panel switching information.

One aspect provides a UE for wireless communications. The UE includes a memory and a processor coupled to the memory. The processor and memory are configured to receive MAC CE signaling activating one or more TCI codepoints. Each of the TCI codepoints maps to one or more TCI states configured for the UE. Each of the TCI states is separately applicable to an uplink transmission or a downlink transmission or jointly applicable to both uplink and downlink transmissions. The processor and memory are further configured to receive a first DCI indicating a first TCI codepoint from the activated TCI codepoints. The processor and memory are configured to receive a second DCI scheduling an uplink transmission from the UE or a downlink transmission to the UE, the second DCI conveying panel switching information to the UE. The processor and memory are configured to process the scheduled uplink transmission or downlink transmission based on one or more TCI states mapped to the first TCI codepoint and the panel switching information.

One aspect provides a non-transitory computer readable medium storing instructions that when executed by a UE cause the UE to receive MAC CE signaling activating one or more TCI codepoints. Each of the TCI codepoints maps to one or more TCI states configured for the UE. Each of the TCI states is separately applicable to an uplink transmission or a downlink transmission or jointly applicable to both uplink and downlink transmissions. The non-transitory computer readable medium further stores instructions, when executed, cause the UE to receive a first DCI indicating a first TCI codepoint from the activated TCI codepoints. The non-transitory computer readable medium further stores instructions, when executed, cause the UE to receive a second DCI scheduling an uplink transmission from the UE or a downlink transmission to the UE, the second DCI conveying panel switching information to the UE. The non-transitory computer readable medium further stores instructions, when executed, cause the UE to process the scheduled uplink transmission or downlink transmission based on one or more TCI states mapped to the first TCI codepoint and the panel switching information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

In one aspect, a method for wireless communications by a user equipment (UE) includes receiving media access control (MAC) control element (CE) signaling activating one or more transmission configuration indicator (TCI) codepoints, wherein each of the TCI codepoints maps to one or more TCI states configured for the UE, wherein each of the TCI states is separately applicable to an uplink transmission or a downlink transmission or jointly applicable to both uplink and downlink transmissions; receiving a first downlink control information (DCI) indicating a first TCI codepoint from the activated TCI codepoints; receiving a second DCI scheduling an uplink transmission from the UE or a downlink transmission to the UE, the second DCI conveying panel switching information to the UE; and processing the scheduled uplink transmission or downlink transmission based on one or more TCI states mapped to the first TCI codepoint and the panel switching information.

In one aspect, a method for wireless communications by a network entity includes transmitting, to a UE, MAC CE signaling activating one or more TCI codepoints configured therein, wherein each of the TCI codepoints maps to one or more TCI states configured for the UE, and wherein each of the TCI states is separately applicable to an uplink transmission or a downlink transmission or jointly applicable to both uplink and downlink transmissions; transmitting, to the UE, a first DCI indicating a first TCI codepoint from the activated TCI codepoints; transmitting, to the UE, a second DCI scheduling an uplink transmission from the UE or a downlink transmission to the UE, the second DCI conveying panel switching information to the UE; and processing the scheduled uplink transmission or downlink transmission based on one or more TCI states mapped to the first TCI codepoint and the panel switching information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIGS. 4A-4B depicts example multiple transmission reception point (multi-TRP) transmission scenarios, in accordance with certain aspects of the present disclosure.

FIG. 5 depicts an example mechanism for activating transmission configuration indicator (TCI) states, in accordance with certain aspects of the present disclosure.

FIG. 6 depicts an example codepoint having a two-bit indication for one or two TRPs, in accordance with certain aspects of the present disclosure.

FIG. 7 depicts an example call flow diagram between a user equipment (UE) and one or more TRPs, in accordance with certain aspects of the present disclosure.

FIG. 8 depicts example DCIs indicating downlink TCI states for one or two panels, in accordance with certain aspects of the present disclosure.

FIG. 9 depicts example DCIs indicating uplink TCI states for one or two panels, in accordance with certain aspects of the present disclosure.

FIG. 10 depicts an example call flow diagram between a UE and one or more TRPs, in accordance with certain aspects of the present disclosure.

FIG. 11 depicts an example call flow diagram between a UE and one or more TRPs, in accordance with certain aspects of the present disclosure.

FIG. 12 depicts example DCIs indicating joint TCI states for one or two panels, in accordance with certain aspects of the present disclosure.

FIGS. 13 and 14 show example methods for activation and indication of TCI codepoints and panel switching information according to aspects of the present disclosure.

FIGS. 15 and 16 show examples of a communications device according to aspects of the present disclosure.

### DETAILED DESCRIPTION

Aspects of the present disclosure provide apparatuses, methods, processing systems, and computer-readable mediums for configuring user equipment (UE) beam switching in multiple transmission/reception points (multi-TRPs) communications.

For example, aspects of the present disclosure provides techniques for harmonizing downlink panel switching and uplink panel switching using transmission configuration indicator (TCI) codepoints. In some cases, a single downlink control information (DCI) may convey multiple TCI states for multiple panels or multi-TRPs. Downlink panel switching and uplink panel switching may be indicated via DCI signaling, medium access control (MAC) control element (CE) signaling, or a combination of DCI and MAC CE signaling.

In one example, a UE receives a MAC CE activating one or more TCI codepoints that map to one or more TCI states configured for the UE. Each of the TCI states is separately applicable to an uplink transmission or a downlink transmission or jointly applicable to both uplink and downlink transmissions. The UE may receive a first DCI indicating a first TCI codepoint from the activated TCI codepoints, and a second DCI scheduling an uplink transmission from the UE or a downlink transmission to the UE. The second DCI conveys panel switching information to the UE. The UE processes the scheduled uplink transmission or downlink transmission based on one or more TCI states mapped to the first TCI codepoint and the panel switching information.

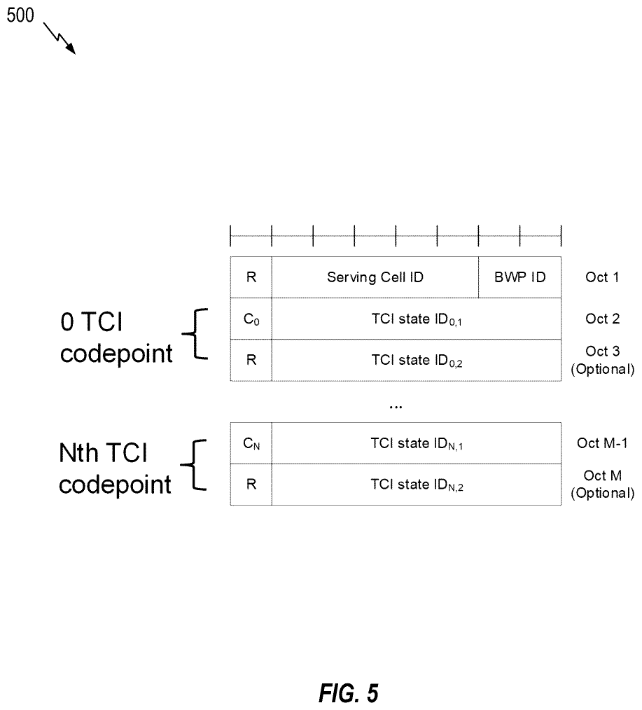

In some systems, such as new radio (NR) Release 16, the number of TCI states in a TCI codepoint is applied as panel switching indication for UE's downlink multi-panel reception. One DCI may have one TCI codepoint, which may be mapped to one or two TCI states (further discussed in relation to FIG. 5 below). In Release 17, dynamic bits in uplink DCI are used for panel switching indication for uplink multi-panel transmissions. For example, two bits (e.g., 00, 01, 10, or 11) may indicate SRS resource sets for two TRPs. Therefore, potential conflicts may arise when a DCI schedules two panels in downlink panel switching when the same two panels are subject to uplink panel switching using dynamic switching bits. The present disclosure provides techniques for avoiding such potential conflict and harmonizes panel switching indication in multi-TRP or multi-panel operations.

According aspects of the present disclosure, some downlink DCI may be applied to indicate a TCI codepoint for a unified TCI indication. On beam indication signaling medium to support joint or separate downlink or uplink beam indication, a unified TCI framework may be implemented. In a first example, a UE may be configured with separate downlink and uplink TCI states and activated by MAC CE for a TCI codepoint separately indicating downlink TCI states and uplink TCI states. In a second example, a UE may be configured with joint TCI states for both downlink and uplink panel switching and activated by MAC CE for a TCI codepoint indicating joint TCI states. This way, the UE avoids potential conflicts in single DCI based multi-TRP operations. Benefits of the present disclosure include resolving potential signaling conflicts and reducing control signaling overhead, as TCI states for multiple panels may be configured and activated with a reduced number of signaling than existing implementations.

### Introduction to Wireless Communication Networks

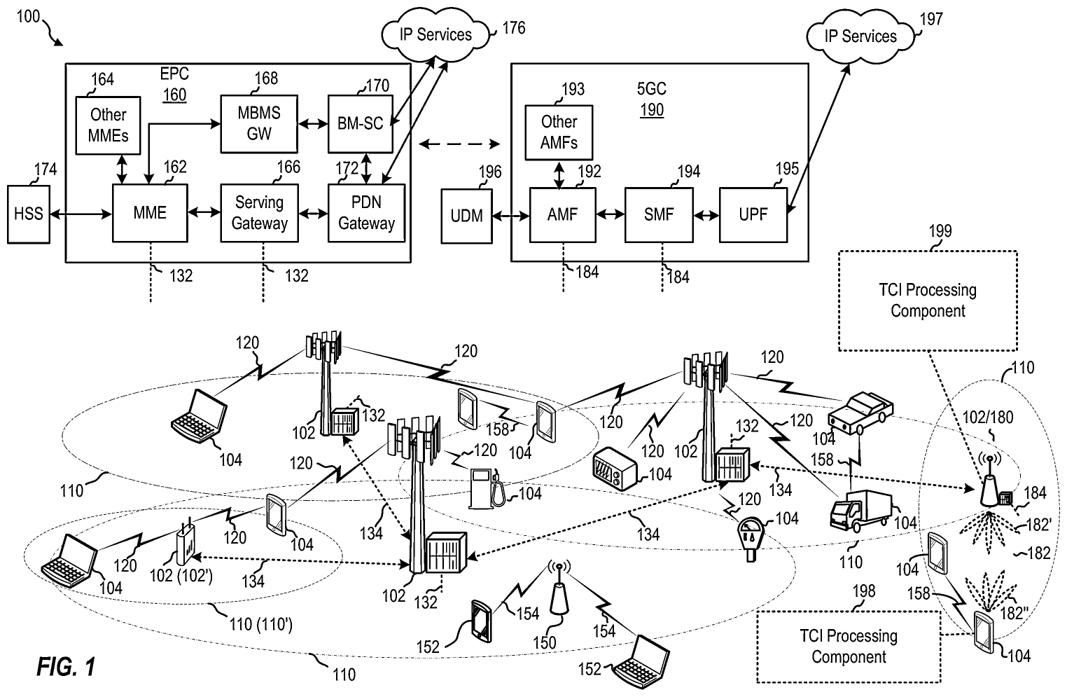

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes TCI processing component 199, which may be configured to process transmissions based on TCI states mapped to TCI codepoints indicated Wireless network 100 further includes TCI processing component 198, which may be used configured to perform downlink and uplink panel switching according to indicated TCI states.

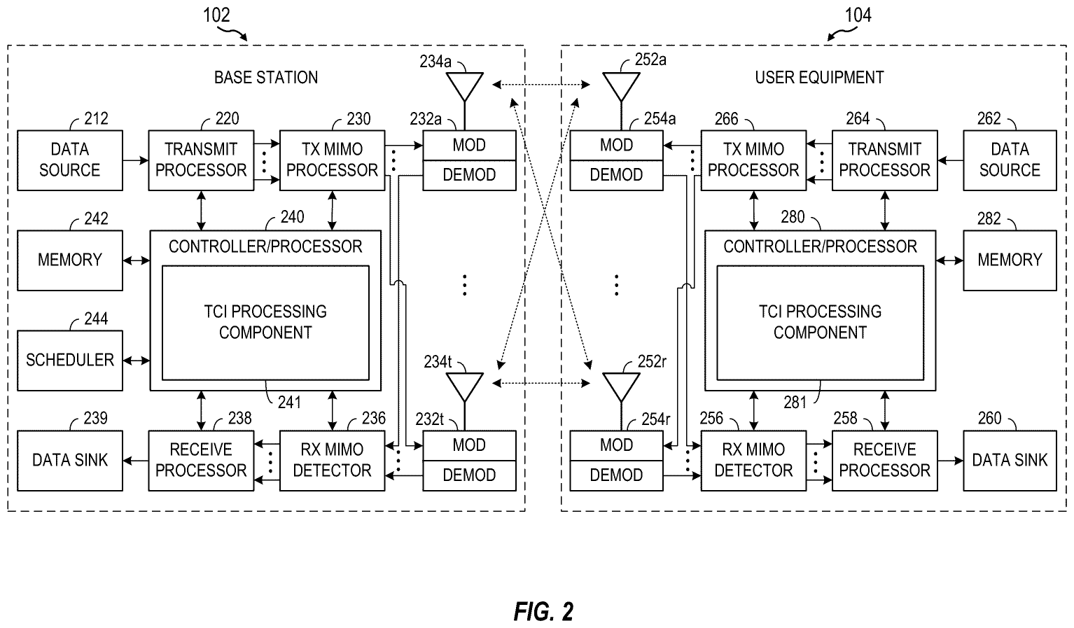

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes TCI processing component 241, which may be representative of TCI processing component 199 of FIG. 1. Notably, while depicted as an aspect of controller/processor 240, TCI processing component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes TCI processing component 281, which may be representative of TCI processing component 198 of FIG. 1. Notably, while depicted as an aspect of controller/processor 280, TCI processing component 281 may be implemented additionally or alternatively in various other aspects of user equipment 104 in other implementations.

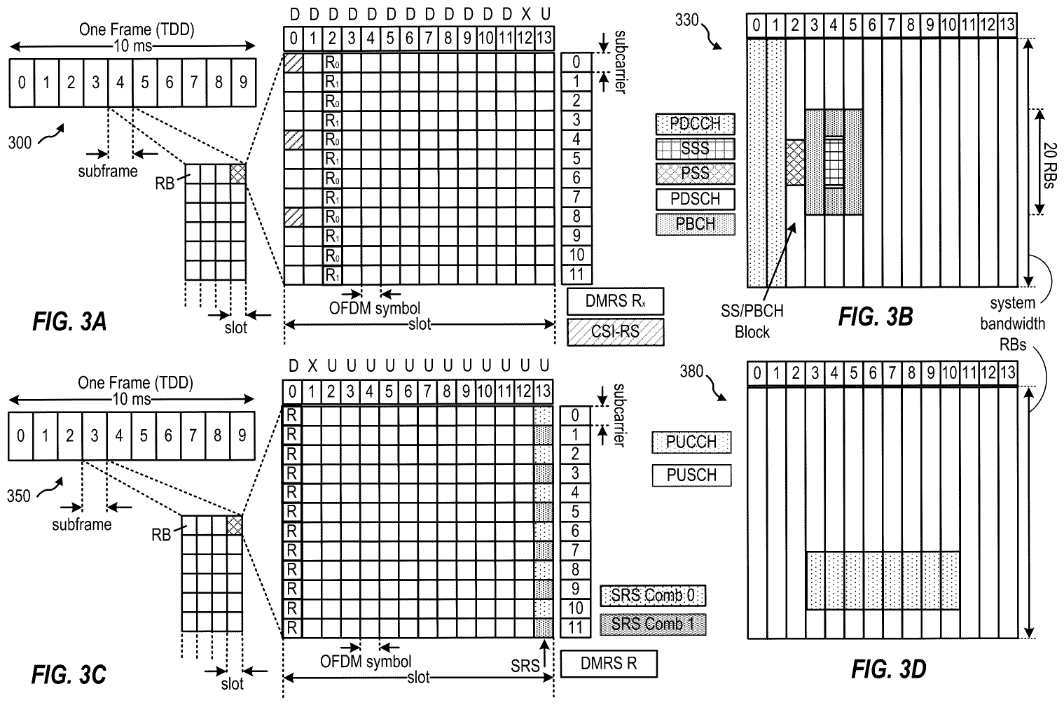

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided, into various classes, bands, channels, or other features. The subdivision is often provided based on wavelength and frequency, where frequency may also be referred to as a carrier, a subcarrier, a frequency channel, a tone, or a subband.

In 5G, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is sometimes referred to (interchangeably) as a “millimeter wave” (“mmW” or “mmWave”) band in documents and articles, despite being different from the extremely high frequency (EHF) band (30 GHz-300 GHz), which is identified by the International Telecommunications Union (ITU) as a “millimeter wave” band because wavelengths at these frequencies are between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Communications using the mmWave/near mmWave radio frequency band (e.g., 3 GHZ-300 GHz) may have higher path loss and a shorter range compared to lower frequency communications. Accordingly, in FIG. 1, mmWave base station 180 may utilize beamforming 182 with the UE 104 to improve path loss and range. To do so, base station 180 and the UE 104 may each include a plurality of antennas, such as antenna elements, antenna panels, and/or antenna arrays to facilitate the beamforming. Therefore, multiple transmission reception points (multi-TRPs) or communications via multiple radio access links using the plurality of antennas or panels may be used to counteract path loss or otherwise to improve channel reliability.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Further, as described herein, panel switching for two or more panels in single DCI multi-TRP scenarios may facilitate mmWave communication deployments. Multi-TRP mmWave transmission may improve service connectivity and reliability, including high mobility scenarios or ultra-dense deployments. For example, multi-TRP may facilitate seamless handover by ensuring the UE to have strong reception power with at least one TRP.

### Example Multi-TRP Scenarios

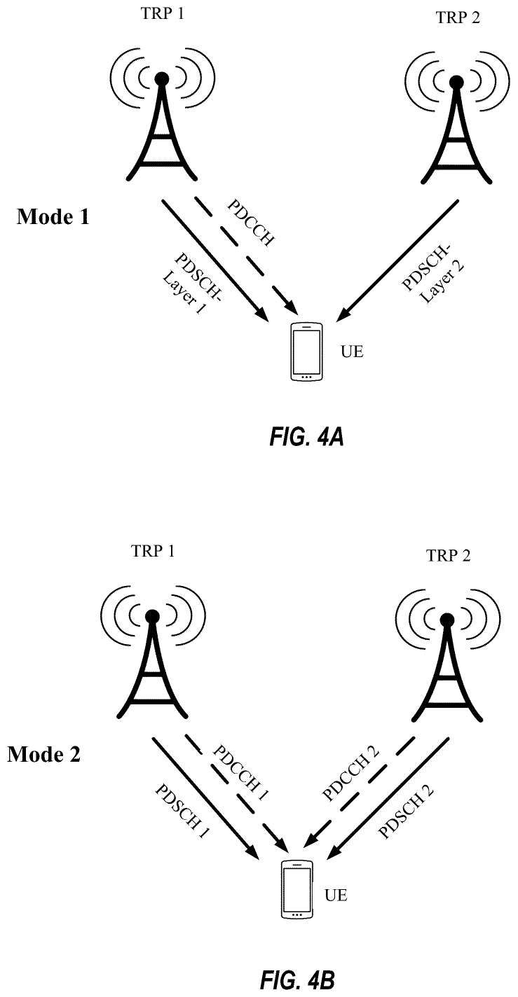

In certain systems (e.g., NR Release 16), multi-TRP operation may be introduced to increase system capacity as well as reliability. Various modes of operation are supported for multi-TRP operation. FIGS. 4A-4B depicts example multiple transmission reception point (multi-TRP) transmission scenarios, in accordance with certain aspects of the present disclosure.

In a first mode (Mode 1), a single PDCCH schedules single PDSCH from multiple TRPs, as illustrated in FIG. 4A. The single PDCCH may carry DCI (e.g., single DCI to schedule a multi-transmission configuration indicator (TCI) transmission). The TCI field in the DCI may indicate two TCI states for the purpose of receiving the scheduled PDSCH. The TCI field may point to two quasi-co-location (QCL) relationships. The DCI may indicate one or more TCI codepoints corresponding to one or more TCI states. In this mode, different TRPs transmit different spatial layers in overlapping RBs/symbols (spatial division multiplexing-SDM). The different TRPs transmit in different RBs (frequency division multiplexing-FDM) and may transmit in different OFDM symbols (time division multiplexing-TDM). This mode assumes a backhaul with little or virtually no delay.

In a second mode (Mode 2), multiple PDCCHs schedule respective PDSCH from multiple TRPs, as shown in FIG. 4B. This mode can be utilized in both non-ideal and ideal backhauls. To support multiple PDCCH monitoring, up to 5 Control Resource Sets (CORESETs) can be configured with up to 3 CORESETs per TRP. As used herein, the term CORESET generally refers to a set of physical resources (e.g., a specific area on the NR Downlink Resource Grid) and a set of parameters that is used to carry PDCCH/DCI. For example, a CORESET may by similar in area to an LTE PDCCH area (e.g., the first 1, 2, 3, 4 OFDM symbols in a subframe).

In some cases, TRP differentiation at the UE side may be based on CORESET groups. CORESET groups may be defined by higher layer signaling of an index per CORESET which can be used to group the CORESETs. For example, for 2 CORESET groups, two indexes may be used (i.e. index=0 and index=1). Thus, a UE may monitor for transmissions in different CORESET groups and infer that transmissions sent in different CORESET groups come from different TRPs. Otherwise, the notion of different TRPs may be transparent to the UE.

### Overview of QCL and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL′d”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TI-RS-SetConfig that indicates different QCL assumptions between certain source and target signals.

In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

A UE receives TCI configuration information (e.g., TCI-RS-SetConfig) that typically contains parameters that configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial Rx parameter},
   Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

### Overview of TCI State Activation

FIG. 5 depicts an example MAC CE 500 for activation/deactivation of TCI states. The MAC CE may be used, for example, for a single PDCCH multi-TRP scenario (shown in FIG. 4A).

As illustrated, each of 0 through N TCI codepoints may be mapped to one or two TCI states, each TCI state identified by a TCI state ID. For each codepoint i, at least a first TCI state ID_{i,1} is present and a field Cᵢ indicates whether (a corresponding octet containing) a second TCI state ID_{i,2} is present. Once activated via the MAC CE, a particular TCI codepoint i (=0 to N) is indicated via DCI to indicate the corresponding TCI state(s).

In some cases, the number of TCI states in a TCI codepoint may be applied for panel switching indication for DL multi-panel reception. For example, if one TCI state is mapped in the TCI codepoint, this may indicate a single TRP/panel reception. On the other hand, if two TCI states are mapped in the TCI codepoint, this may indicate multiple TRP/panel reception.

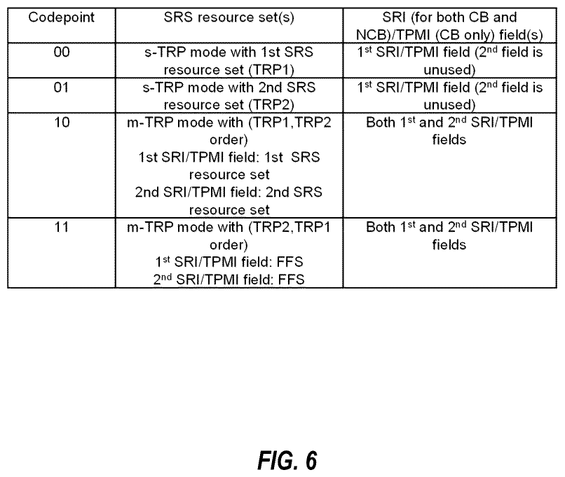

In some cases panel switching may be indicated via dynamic bits in an uplink DCI (e.g., a DCI scheduling an uplink transmission). FIG. 6 depicts an example codepoint for such dynamic bits, in accordance with certain aspects of the present disclosure. The dynamic switching bits may indicate a single panel transmission, if mapped to one SRS resource identifier (SRI) associated with one TRP (e.g., TRP1 or TRP2) or may indicate a multi-panel transmission if mapped to two SRIs associated with both TRPs (e.g., TRP1 and TRP2).

In the illustrated example, the dynamic switching bits “00” indicate an s-TRP (single-TRP) mode with the first SRS resource set (SRS1 associated with TRP1) where the scheduled uplink transmission is associated with the first SRS resource set, while the dynamic switching bits “01” indicate an s-TRP mode with the second SRS resource set (SRS2 associated with TRP2), where the scheduled uplink transmission is associated with the second SRS resource set.

The dynamic switching bits “10” indicate a multi-TRP mode with both SRS resource sets, in the order of TRP1 and TRP2, where the scheduled uplink transmission has two sets of transmission occasions such that the first set and the second set of transmission occasions are associated with the first and the second SRS resource set respectively, while the dynamic switching bits “11” indicate a multi-TRP mode with both SRS resource sets, in the order of TRP2 and TRP1, where the scheduled uplink transmission has two sets of transmission occasions such that the first set and the second set of transmission occasions are associated with the second and the first SRS resource set respectively.

In some systems (e.g., Release 17), downlink DCI may be applied to indicate a TCI codepoint for unified TCI indication. For example, UE specific (e.g., unicast) DCI may be used to indicate joint or separate downlink or uplink beam indication from the active TCI states. In some cases, DCI formats 1_1 and 1_2 may be reused for beam indication.

In some systems (e.g., Release 16), one DCI can schedules up to two panels in downlink. For example, a DCI indicating a TCI codepoint mapped to two TCI states (TCI state 1 and TCI state 2) may schedule two panels, where a first panel is indicated with TCI state 1 and a second panel is indicated with TCI state 2. A second DCI may schedule one panel (e.g., the first panel indicated with TCI state 1). A third DCI may schedule one panel (e.g., the second panel indicated with TCI state 2). In this manner, activating TCI codepoints mapped to single or multiple TCI states may allow indication single or multi-TRP panel switching via DCI. As noted above, in Release 17, uplink panel switching may be applied by dynamic switching bits in the uplink DCI. A joint TCI state including both downlink TCI state(s) and uplink TCI state(s) may be indicated in downlink and uplink transmissions. Therefore, the downlink panel switching in Release 16 using TCI codepoint may conflict with another TCI codepoint indicating uplink panel switching in Release 17. Aspects of the present disclosure provides techniques that may help avoid potential ambiguity in uplink panel switching and downlink panel switching indications provided in different manners.

### Aspects of Panel Switching Indication in Multi-TRP or Multi-Panel Operations

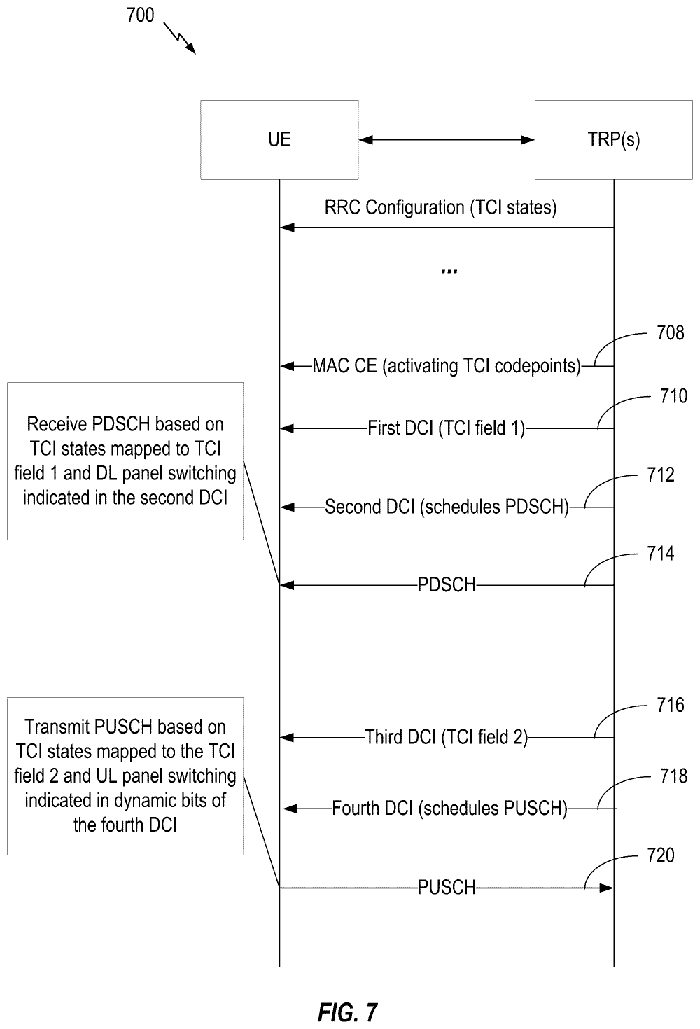

FIG. 7 depicts an example call flow diagram 700 that illustrates panel switching indication, in accordance with certain aspects of the present disclosure. The call flow diagram 700 illustrates an example of UE configured with separate downlink and uplink TCI states (e.g., according to Releases 16 and 17 aforementioned) in single DCI multi-TRP operations (with a TRP or set of TRPs). Each of the TCI states may be separately applicable to an uplink or a downlink transmission.

As shown, the UE may be configured with one or more TCI states via radio resource control (RRC) signaling. At 708, a MAC CE may be sent to activate one or more of the configured TCI states. As described with reference to FIG. 5, the MAC CE may provide a mapping of TCI codepoints in DCI to one or more of the TCI states configured for the UE.

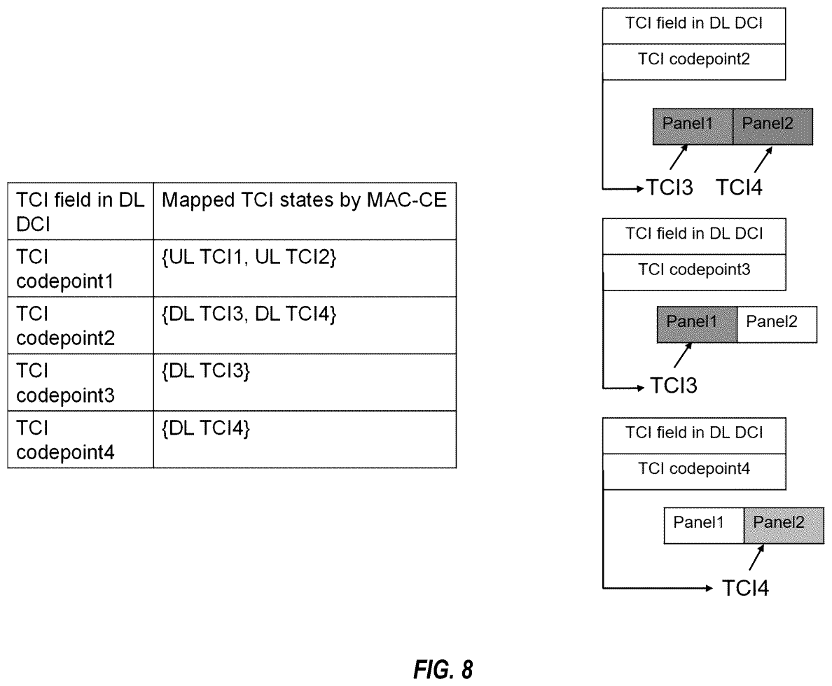

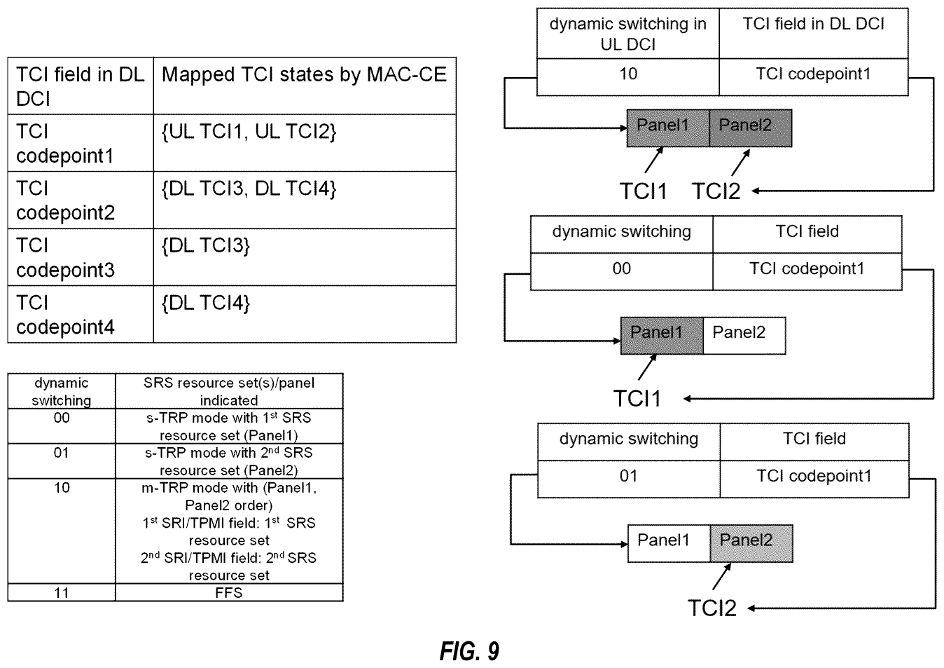

At 710, the TRP transmits a first DCI including a TCI field (TCI field 1) indicating a first TCI codepoint from the TCI codepoints activated via the MAC CE. Examples of the first TCI codepoint are shown in FIGS. 8 and 9. For example, in FIG. 8, four codepoints (1 through 4) in the “TCI field in downlink (DL) DCI” are mapped to corresponding TCI states in the “Mapped TCI states by MAC-CE” field. TCI codepoint 1 is mapped to uplink TCI1 and uplink TCI2; TCI codepoint 2 is mapped to downlink TCI3 and downlink TCI4; TCI codepoint 3 is mapped to downlink TCI3; and TCI codepoint 4 is mapped to downlink TCI 4. Uplink TCI may provide the spatial transmit filter information for transmitting at least one uplink channels, such as UE-dedicated PUSCH and UE-dedicated PUCCH. Downlink TCI may provide the QCL information for receiving at least one downlink channels, such as UE-dedicated PDSCH and UE-dedicated PDCCH.

At 710, the first DCI indicates any one of the four example codepoints via the TCI field 1. At 712, the TRP transmits a second DCI to the UE to schedule PDSCH. The second DCI may indicate downlink panel switching using the downlink TCI states mapped by the TCI codepoints. For example, the UE may determine whether the second DCI indicates a single-TRP or multi-TRP reception based on the number of downlink TCI states (e.g., one of the DL TCI states of FIG. 8) activated by the TCI codepoint indicated in the second DCI (e.g., in the TCI field in DL DCI of FIG. 8). As shown in FIG. 8, TCI codepoints 2, 3, and 4 are respectively mapped to (1) multi-panel of downlink TCI3 and TCI4 for both panel 1 and panel 2, (2) single panel of TCI3 for panel 1 only, and (3) single panel of TCI 4 for panel 2 only. Anyone of the DL DCIs (i.e., first, second, and third) in FIG. 8 may be the second DCI at 712 of FIG. 7.

At 714, the one or more TRPs transmit PDSCH to the UE, which receives the PDSCH based on TCI states mapped to the first TCI codepoint. At 716, the TRP transmits a third DCI indicating a second TCI codepoint using TCI field 2 to the UE. The second TCI codepoint may be mapped to two uplink TCI states, as shown in {UL TCI1, UL TCI2} in the “Mapped TCI states by MAC-CE” column mapped to TCI codepoint 1. At 718, the TRP transmits a fourth DCI scheduling an uplink transmission (PUSCH) from the UE. The fourth DCI may include panel switching information, such as dynamic switching bits indicating single or multiple TRPs/panels as shown in FIG. 9. The fourth DCI at 718 may indicate the corresponding TCI1, TCI2, or both TCI1 and TCI2 based on the TCI codepoint indicated in the third DCI.

The UE then transmits, at 720, the PUSCH scheduled by the fourth DCI based on one or more TCI states mapped to the second TCI codepoint and the uplink panel switching indicated by the dynamic switching bits of the fourth DCI.

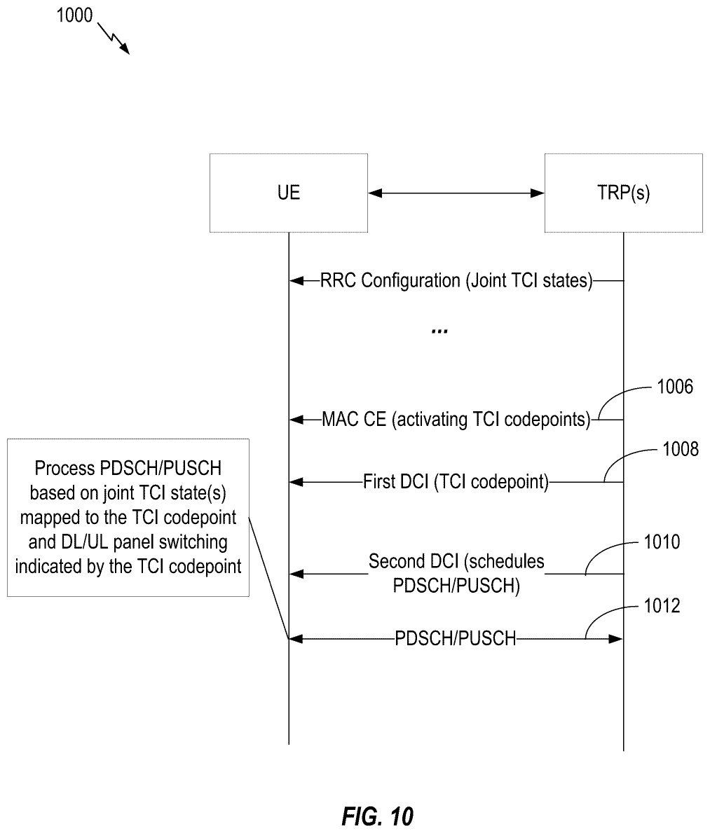

FIG. 10 depicts an example call flow diagram 1000 between a UE and one or more TRPs, in accordance with certain aspects of the present disclosure. The call flow diagram 1000 illustrates an example of UE configured with joint TCI states in single DCI multi-TRP operations. In particular, the TCI codepoint activated by MAC CE may map to a single or a pair of joint TCI states. The joint TCI states may be activated in both uplink and downlink multi-TRP or multi-panel transmissions. For example, for both downlink and uplink panel switching, the UE may be indicated with a TCI codepoint in a downlink DCI.

As shown in FIG. 10, the one or more joint TCI states may be configured in the UE when the one or more TRPs transmit RRC configurations to the UE. A joint TCI may provide the spatial transmit filter information for transmitting at least one uplink channel, such as UE-dedicated PUSCH and UE-dedicated PUCCH. The joint TCI may further provide the QCL information for receiving at least one downlink channels, such as UE-dedicated PDSCH and UE-dedicated PDCCH. The one or more joint TCI states may be activated by a TCI codepoint mapped thereto. At 1006, the TRP transmits MAC CE signaling to the UE to activate one or more TCI codepoints. At 1008, the one or more TRPs transmit a first DCI indicating a first TCI codepoint. The first TCI codepoint maps to one or more joint TCI states. Each joint TCI state may be applicable to uplink and downlink transmissions. For example, for multi-TRP receptions or transmissions, a pair of joint TCI states may be indicated via the first codepoint of the first DCI. For single-TRP reception or transmission, a single joint TCI state may be indicated in the TCI codepoint instead. At 1010, the TRP transmits a second DCI scheduling downlink or uplink transmissions (e.g., PDSCH or PUSCH). The UE processes or transmits, at 1012, the PDSCH or PUSCH based on the joint TCI states mapped to TCI codepoint in the first DCI and the downlink and uplink panel switching indicated by this same TCI codepoint.

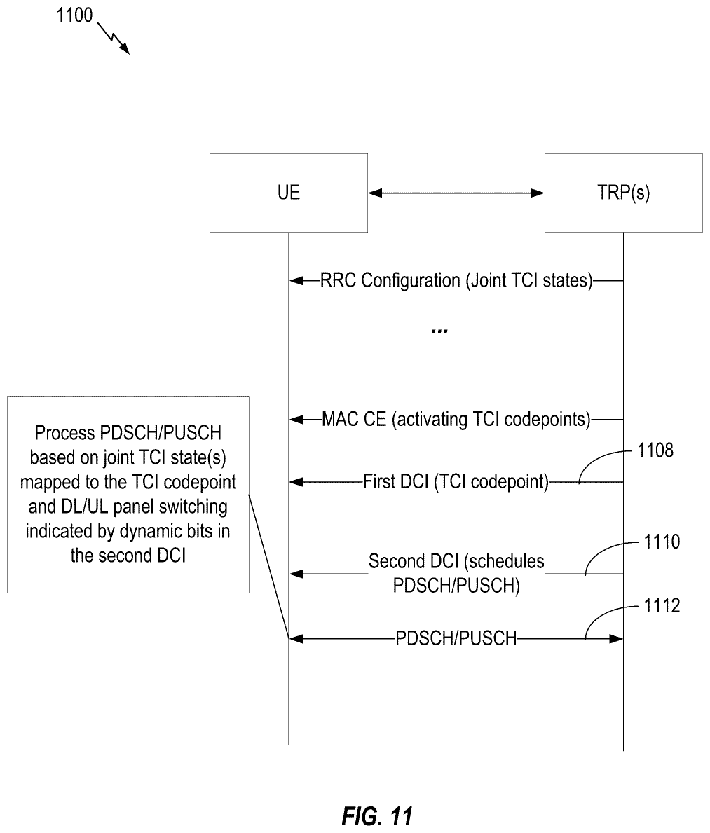

In some cases, instead of downlink or uplink panel switching being indicated by the TCI codepoint carried by a DCI, the downlink or uplink panel switching may be indicated using dynamic bits in a scheduling DCI (e.g., the DCI that schedules the PDSCH/PUSCH) as shown in FIG. 11.

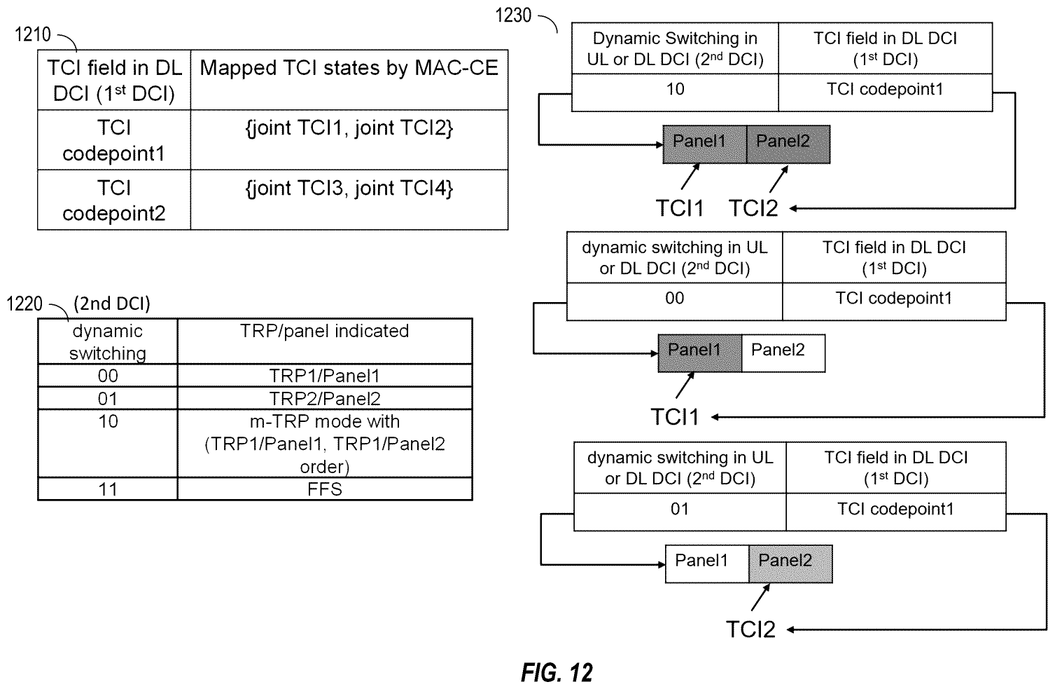

Compared to FIG. 10, the second DCI at 1110 in FIG. 11 may further include dynamic switching bits for indicating uplink or downlink panel switching. An example of joint TCI states panel switching indication with dynamic bits is shown in FIG. 12.

As shown in FIG. 12, in table 1210, each of the activated TCI codepoints may be mapped to joint TCI states by MAC CE. The first DCI (e.g., at 1108 of FIG. 11) may include a TCI field (e.g., “TCI field in DL DCI” of the table 1210) indicating a TCI codepoint (e.g., “TCI codepoint1” or “TCI codepoint2”). Each TCI codepoint is mapped to a set of joint TCI states (e.g., “joint TCI1” and “joint TCI2”). The second DCI (e.g., at 1110 of FIG. 11) may include dynamic switching bits for the TRP or panel indicated (e.g., “TRP/panel indicated” of the second table 1220 in FIG. 12).

As shown in the examples 1230 of FIG. 12, dynamic switching of one or more panels in uplink or downlink DCI (e.g., the second DCI scheduling PUSCH or PDSCH) may be indicated by the two-bit dynamic switching bits. For example, the dynamic switching bits “10” indicate joint TCI states TCI1 and TCI2 (mapped to “TCI codepoint1” indicated by the first DCI) to Panel1 and Panel2 respectively. Similarly, dynamic switching bits “00” indicate TCI applies to Panel1, while dynamic switching bits “01” indicate TCI2 applies to Panel2.

Returning to FIG. 11, at 1112, the UE processes the PDSCH or PUSCH based on the TCI states mapped to the TCI codepoint indicated by the first DCI, and processes the PDSCH or PUSCH based on the downlink or uplink panel switching indicated by the dynamic bits in the second DCI. For example, when the second DCI scheduling PUSCH with dynamic switching bits indicating multiple joint TCI states to respective multiple panels, the UE transmits the PUSCH to the TRPs using the multiple panels according to the indication. When the second DCI scheduling PDSCH with dynamic switching bits indicating multiple joint TCI states to respective multiple panels, the UE applies the TCI states to the multiple panels according to the indication and receives PDSCH from the TRPs.

### Example Methods

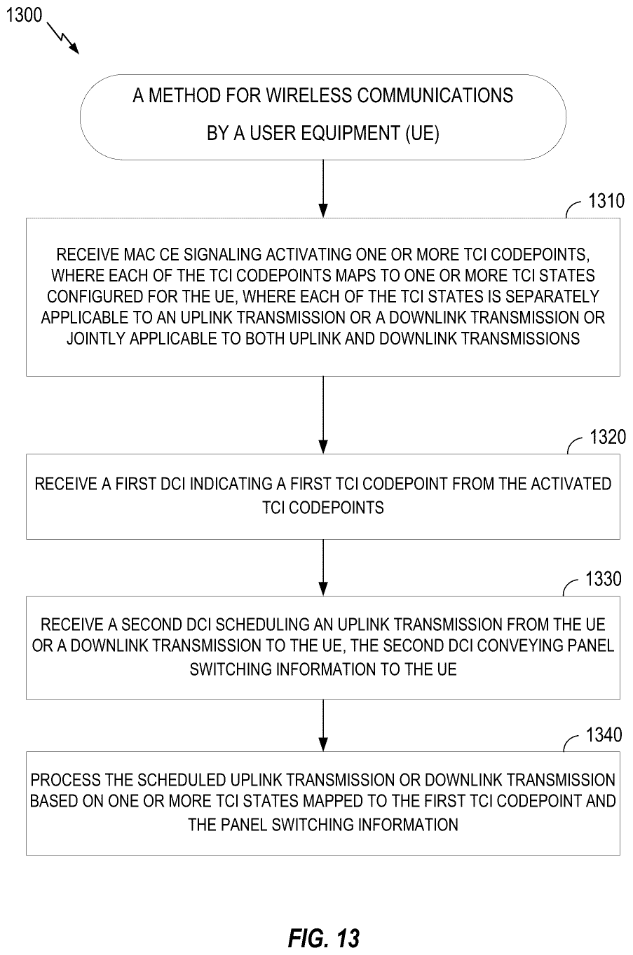

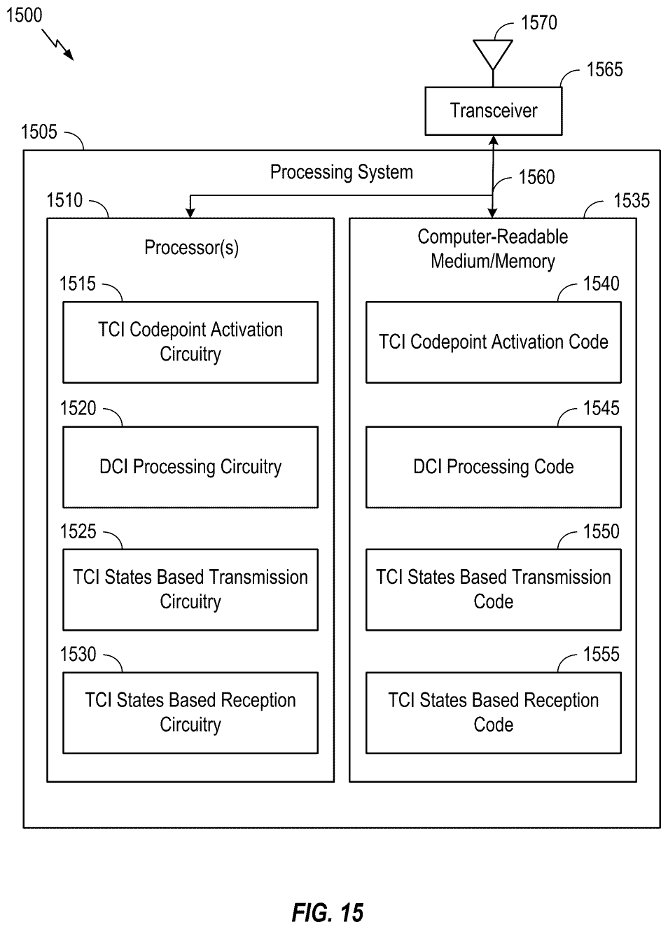

FIG. 13 shows an example of a method 1300 for activation and indication of TCI codepoints and panel switching information according to aspects of the present disclosure. In some aspects, a user equipment, such as UE 104 of FIGS. 1 and 2, or processing system 1505 of FIG. 15, may perform the method 1300.

At operation 1310, the system receives MAC CE signaling activating one or more TCI codepoints, where each of the TCI codepoints maps to one or more TCI states configured for the UE, and where each of the TCI states is separately applicable to an uplink transmission or a downlink transmission or jointly applicable to both uplink and downlink transmissions. In some cases, the operations of this step refer to, or may be performed by, TCI codepoint activation circuitry as described with reference to FIG. 15.

At operation 1320, the system receives a first DCI indicating a first TCI codepoint from the activated TCI codepoints. In some cases, the operations of this step refer to, or may be performed by, DCI processing circuitry as described with reference to FIG. 15.

At operation 1330, the system receives a second DCI scheduling an uplink transmission from the UE or a downlink transmission to the UE, the second DCI conveying panel switching information to the UE. In some cases, the operations of this step refer to, or may be performed by, DCI processing circuitry as described with reference to FIG. 15.

At operation 1340, the system processes the scheduled uplink transmission or downlink transmission based on one or more TCI states mapped to the first TCI codepoint and the panel switching information. In some cases, the operations of this step refer to, or may be performed by, TCI states based transmission circuitry as described with reference to FIG. 15.

In some aspects, the second DCI schedules the downlink transmission to the UE and the first TCI codepoint is mapped to one or more downlink TCI states.

In some aspects, the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

In some aspects, the method 1300 includes receiving a third DCI indicating a second TCI codepoint from the activated TCI codepoints. In some aspects, the method 1300 includes receiving a fourth DCI scheduling an uplink transmission from the UE. In some aspects, the method 1300 includes transmitting the uplink transmission scheduled by the fourth DCI based on one or more TCI states mapped to the second TCI codepoint and the panel switching information conveyed via at least one of the third or fourth DCI. In some aspects, the panel switching information comprises one or more dynamic switching bits indicated in the fourth DCI.

In some aspects, the second DCI schedules the uplink transmission from the UE and the first TCI codepoint is mapped to a pair of uplink TCI states. In some aspects, the panel switching information comprises one or more dynamic switching bits indicated in the second DCI.

In some aspects, the first TCI codepoint maps to one or more joint TCI states, wherein each joint TCI state is applicable to uplink and downlink transmissions. In some aspects, the panel switching information is indicated by the first TCI codepoint, and the panel switching information indicates multi-TRP reception or transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state. In some aspects, the first TCI codepoint maps to a pair of joint TCI states. In some aspects, the panel switching information is conveyed by dynamic switching bits in the second DCI for both downlink and uplink transmissions.

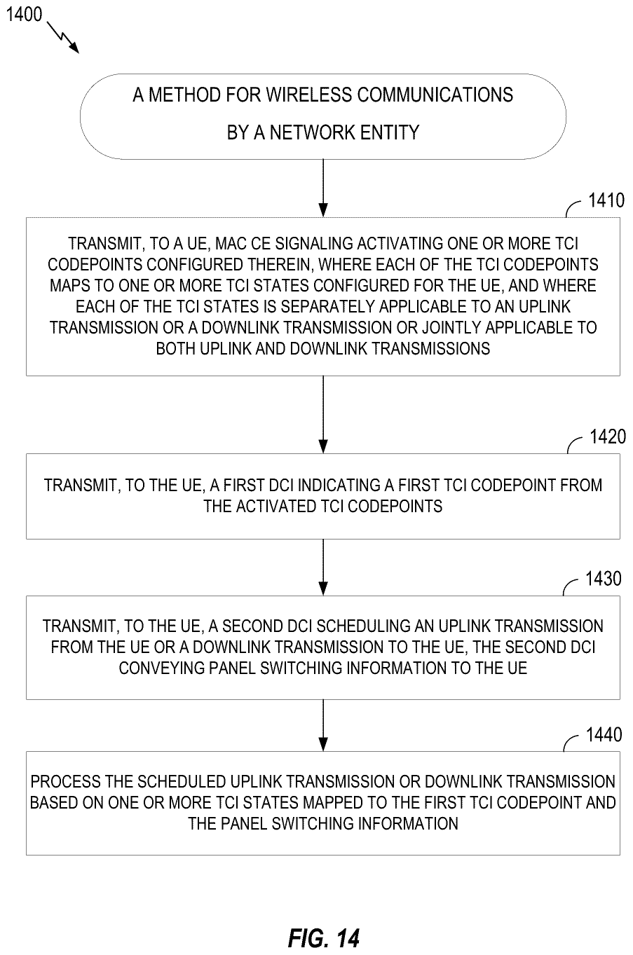

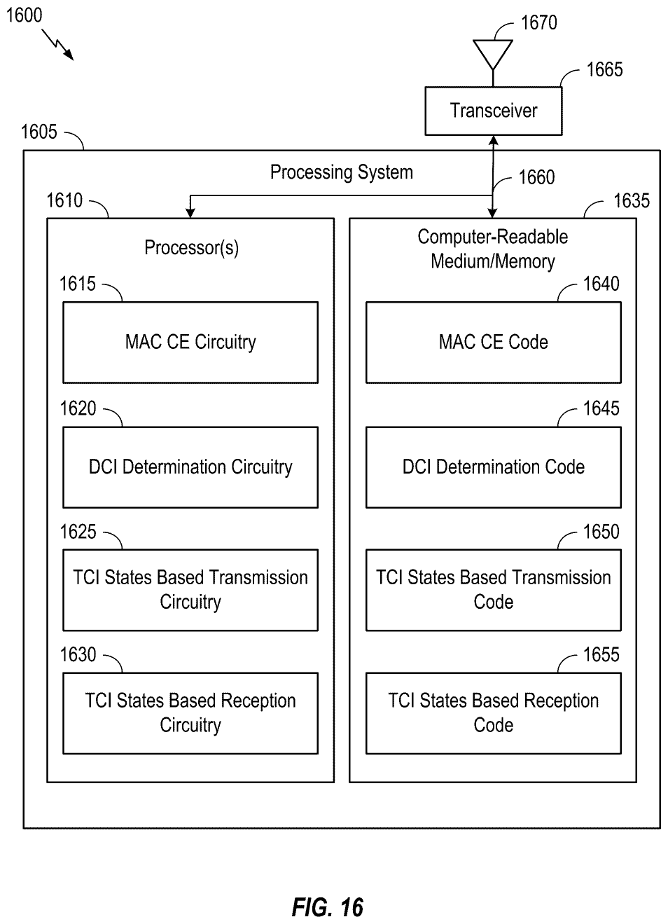

FIG. 14 shows an example of a method 1400 for activation and indication of TCI codepoints and panel switching information according to aspects of the present disclosure. In some aspects, a base station, such as base station 102 of FIGS. 1 and 2, or processing system 1605 of FIG. 16, may perform the method 1400.

At operation 1410, the system transmits, to a UE, MAC CE signaling activating one or more TCI codepoints configured therein, where each of the TCI codepoints maps to one or more TCI states configured for the UE, and where each of the TCI states is separately applicable to an uplink transmission or a downlink transmission or jointly applicable to both uplink and downlink transmissions. In some cases, the operations of this step refer to, or may be performed by, MAC CE circuitry as described with reference to FIG. 16.

At operation 1420, the system transmits, to the UE, a first DCI indicating a first TCI codepoint from the activated TCI codepoints. In some cases, the operations of this step refer to, or may be performed by, DCI determination circuitry as described with reference to FIG. 16.

At operation 1430, the system transmits, to the UE, a second DCI scheduling an uplink transmission from the UE or a downlink transmission to the UE, the second DCI conveying panel switching information to the UE. In some cases, the operations of this step refer to, or may be performed by, DCI determination circuitry as described with reference to FIG. 16.

At operation 1440, the system processes the scheduled uplink transmission or downlink transmission based on one or more TCI states mapped to the first TCI codepoint and the panel switching information. In some cases, the operations of this step refer to, or may be performed by, TCI states based transmission circuitry as described with reference to FIG. 16.

In some aspects, the second DCI schedules the downlink transmission to the UE and the first TCI codepoint is mapped to one or more downlink TCI states. In some aspects, the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

In some aspects, the method 1400 includes transmitting, to the UE, a third DCI indicating a second TCI codepoint from the activated TCI codepoints. In some aspects, the method 1400 includes transmitting, to the UE, a fourth DCI scheduling an uplink transmission from the UE. In some aspects, the method 1400 includes receiving, from the UE, the uplink transmission scheduled by the fourth DCI based on one or more TCI states mapped to the second TCI codepoint and the panel switching information conveyed via at least one of the third or fourth DCI. In some aspects, the panel switching information comprises one or more dynamic switching bits indicated in the fourth DCI.

In some aspects, the second DCI schedules the uplink transmission from the UE and the first TCI codepoint is mapped to a pair of uplink TCI states. In some aspects, the panel switching information comprises one or more dynamic switching bits indicated in the second DCI.

In some aspects, the first TCI codepoint maps to one or more joint TCI states, wherein each joint TCI state is applicable to uplink and downlink transmissions. In some aspects, the panel switching information is indicated by the first TCI codepoint, and the panel switching information indicates multi-TRP reception transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state. In some aspects, the first TCI codepoint maps to a pair of joint TCI states. In some aspects, the panel switching information is conveyed by dynamic switching bits in the second DCI for both downlink and uplink transmissions.

### Example Wireless Communication Devices

FIG. 15 depicts an example communications device 1500 that includes various components operable, configured, or adapted to perform operations for the techniques disclosed herein, such as the operations depicted and described with respect to FIG. 13. In some examples, communication device may be a user equipment 104 as described, for example with respect to FIGS. 1 and 2.

Communications device 1500 includes a processing system 1505 coupled to a transceiver 1565 (e.g., a transmitter and/or a receiver). Transceiver 1565 is configured to transmit (or send) and receive signals for the communications device 1500 via an antenna 1570, such as the various signals as described herein. A transceiver 1565 may communicate bi-directionally, via antennas 1570, wired, or wireless links as described above. For example, the transceiver 1565 may represent a wireless transceiver 1565 and may communicate bi-directionally with another wireless transceiver 1565. The transceiver 1565 may also include or be connected to a modem to modulate the packets and provide the modulated packets to for transmission, and to demodulate received packets. In some examples, transceiver 1565 may be tuned to operate at specified frequencies. For example, a modem can configure the transceiver 1565 to operate at a specified frequency and power level based on the communication protocol used by the modem.

Processing system 1505 may be configured to perform processing functions for communications device 1500, including processing signals received and/or to be transmitted by communications device 1500. Processing system 1505 includes one or more processors 1510 coupled to a computer-readable medium/memory 1535 via a bus 1560.

In some examples, one or more processors 1510 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1510 are configured to operate a memory array using a memory controller. In other cases, a memory controller is integrated into the one or more processors 1510. In some cases, the one or more processors 1510 are configured to execute computer-readable instructions stored in a memory to perform various functions. In some aspects, one or more processors 1510 include special purpose components for modem processing, baseband processing, digital signal processing, or transmission processing.

In certain aspects, computer-readable medium/memory 1535 is configured to store instructions (e.g., computer-executable code) that when executed by the one or more processors 1510, cause the one or more processors 1510 to perform the operations illustrated in FIG. 13, or other operations for performing the various techniques discussed herein.

In one aspect, computer-readable medium/memory 1535 includes TCI codepoint activation code 1540, DCI processing code 1545, TCI states based transmission code 1550, and TCI states based reception code 1555.

Examples of a computer-readable medium/memory 1535 include random access memory (RAM), read-only memory (ROM), solid state memory, a hard drive, a hard disk drive, etc. In some examples, computer-readable medium/memory 1535 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1500 may provide means for performing the methods described herein, including with respect to FIG. 13.

In some examples, means for transmitting or sending (or means for outputting for transmission) may include the transceivers 254 and/or antenna(s) 252 of the user equipment 104 illustrated in FIG. 2 and/or transceiver 1565 and antenna 1570 of the communication device in FIG. 15.

In some examples, means for receiving (or means for obtaining) may include the transceivers 254 and/or antenna(s) 252 of the user equipment 104 illustrated in FIG. 2 and/or transceiver 1565 and antenna 1570 of the communication device in FIG. 15.

In some examples, means for processing may include various processing system 1505 components, such as: the one or more processors 1510 in FIG. 15, or aspects of the user equipment 104 depicted in FIG. 2, including receive processor 258, transmit processor 264, TX MIMO processor 266, and/or controller/processor 280.

In one aspect, one or more processors 1510 includes TCI codepoint activation circuitry 1515, DCI processing circuitry 1520, TCI states based transmission circuitry 1525, and TCI states based reception circuitry 1530.

According to some aspects, TCI codepoint activation circuitry 1515 receives MAC CE signaling activating one or more TCI codepoints, where each of the TCI codepoints maps to one or more TCI states configured for the UE, and where each of the TCI states is separately applicable to an uplink transmission or a downlink transmission or jointly applicable to both uplink and downlink transmissions.

According to some aspects, DCI processing circuitry 1520 receives a first DCI indicating a first TCI codepoint from the activated TCI codepoints. In some examples, DCI processing circuitry 1520 receives a second DCI scheduling an uplink transmission from the UE or a downlink transmission to the UE, the second DCI conveying panel switching information to the UE.

In some examples, the second DCI schedules the downlink transmission to the UE and the first TCI codepoint is mapped to one or more downlink TCI states. In some examples, the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

In some examples, the second DCI schedules the uplink transmission from the UE and the first TCI codepoint is mapped to a pair of uplink TCI states. In some examples, the panel switching information includes one or more dynamic switching bits indicated in the second DCI. In some examples, the first TCI codepoint maps to one or more joint TCI states, where each joint TCI state is applicable to uplink and downlink transmissions. In some examples, the panel switching information is indicated by the first TCI codepoint, and the panel switching information indicates multi-TRP reception or transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state. In some examples, the first TCI codepoint maps to a pair of joint TCI states. In some examples, the panel switching information is conveyed by dynamic switching bits in the second DCI for both downlink and uplink transmissions.

According to some aspects, the TCI states based transmission circuitry 1525 processes the scheduled uplink transmission or downlink transmission based on one or more TCI states mapped to the first TCI codepoint and the panel switching information.

In some examples, the DCI processing circuitry 1520 receives a third DCI indicating a second TCI codepoint from the activated TCI codepoints. In some examples, DCI processing circuitry 1520 receives a fourth DCI scheduling an uplink transmission from the UE. In some examples, the panel switching information includes one or more dynamic switching bits indicated in the fourth DCI.

According to some aspects, the TCI states based transmission circuitry 1525 transmits the uplink transmission scheduled by the fourth DCI based on one or more TCI states mapped to the second TCI codepoint and the panel switching information conveyed via at least one of the third or fourth DCI. In aspects, the TCI states based reception circuitry 1530 receives PDSCH based on TCI states mapped to TCI codepoints indicated and downlink panel switching indicated in the DCI. The TCI states may be regular or joint TCI states as discussed in FIGS. 7-12.

Notably, FIG. 15 is just use example, and many other examples and configurations of communication device are possible.

FIG. 16 depicts an example communications device 1600 that includes various components operable, configured, or adapted to perform operations for the techniques disclosed herein, such as the operations depicted and described with respect to FIG. 14. In some examples, communication device may be a base station 102 as described, for example with respect to FIGS. 1 and 2.

Communications device 1600 includes a processing system 1605 coupled to a transceiver 1665 (e.g., a transmitter and/or a receiver). Transceiver 1665 is configured to transmit (or send) and receive signals for the communications device 1600 via an antenna 1670, such as the various signals as described herein. In some aspects, transceiver 1665 is an example of, or includes aspects of, the corresponding element described with reference to FIG. 15.

Processing system 1605 may be configured to perform processing functions for communications device 1600, including processing signals received and/or to be transmitted by communications device 1600. In some aspects, the one or more processors 1610 are examples of, or include aspects of, the corresponding elements described with reference to FIG. 15.

Processing system 1605 includes one or more processors 1610 coupled to a computer-readable medium/memory 1635 via a bus 1660. In certain aspects, computer-readable medium/memory 1635 is configured to store instructions (e.g., computer-executable code) that when executed by the one or more processors 1610, cause the one or more processors 1610 to perform the operations illustrated in FIG. 14, or other operations for performing the various techniques discussed herein. In some aspects, computer-readable medium/memory 1635 is an example of, or includes aspects of, the corresponding element described with reference to FIG. 15.

In one aspect, computer-readable medium/memory 1635 includes MAC CE code 1640, DCI determination code 1645, TCI states based transmission code 1650, and TCI states based reception code 1655.

Various components of communications device 1600 may provide means for performing the methods described herein, including with respect to FIG. 14.

In some examples, means for transmitting or sending (or means for outputting for transmission) may include the transceivers 232 and/or antenna(s) 234 of the base station 102 illustrated in FIG. 2 and/or transceiver 1665 and antenna 1670 of the communication device in FIG. 16.

In some examples, means for receiving (or means for obtaining) may include the transceivers 232 and/or antenna(s) 234 of the base station 102 illustrated in FIG. 2 and/or transceiver 1665 and antenna 1670 of the communication device in FIG. 16.

In some examples, means for processing may include various processing system 1605 components, such as: the one or more processors 1610 in FIG. 16, or aspects of the base station 102 depicted in FIG. 2, including receive processor 238, transmit processor 220, TX MIMO processor 230, and/or controller/processor 240.

In one aspect, one or more processors 1610 includes MAC CE circuitry 1615, DCI determination circuitry 1620, TCI states based transmission circuitry 1625, and TCI states based reception circuitry 1630.

According to some aspects, MAC CE circuitry 1615 transmits, to a UE, MAC CE signaling activating one or more TCI codepoints configured therein, where each of the TCI codepoints maps to one or more TCI states configured for the UE, and where each of the TCI states is separately applicable to an uplink transmission or a downlink transmission or jointly applicable to both uplink and downlink transmissions.

According to some aspects, DCI determination circuitry 1620 transmits, to the UE, a first DCI indicating a first TCI codepoint from the activated TCI codepoints. In some examples, DCI determination circuitry 1620 transmits, to the UE, a second DCI scheduling an uplink transmission from the UE or a downlink transmission to the UE, the second DCI conveying panel switching information to the UE. In some examples, the second DCI schedules the downlink transmission to the UE and the first TCI codepoint is mapped to one or more downlink TCI states. In some examples, the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

In some examples, the second DCI schedules the uplink transmission from the UE and the first TCI codepoint is mapped to a pair of uplink TCI states. In some examples, the panel switching information includes one or more dynamic switching bits indicated in the second DCI. In some examples, the first TCI codepoint maps to one or more joint TCI states, where each joint TCI state is applicable to uplink and downlink transmissions. In some examples, the panel switching information is indicated by the first TCI codepoint, and the panel switching information indicates multi-TRP reception transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state. In some examples, the first TCI codepoint maps to a pair of joint TCI states. In some examples, the panel switching information is conveyed by dynamic switching bits in the second DCI for both downlink and uplink transmissions.

According to some aspects, the TCI states based transmission circuitry 1625 processes the scheduled uplink transmission or downlink transmission based on one or more TCI states mapped to the first TCI codepoint and the panel switching information.

In some examples, the DCI determination circuitry 1620 transmits, to the UE, a third DCI indicating a second TCI codepoint from the activated TCI codepoints. In some examples, DCI determination circuitry 1620 transmits, to the UE, a fourth DCI scheduling an uplink transmission from the UE. In some examples, the panel switching information includes one or more dynamic switching bits indicated in the fourth DCI.

According to some aspects, the TCI states based reception circuitry 1630 receives, from the UE, the uplink transmission scheduled by the fourth DCI based on one or more TCI states mapped to the second TCI codepoint and the panel switching information conveyed via at least one of the third or fourth DCI.

Notably, FIG. 16 is just use example, and many other examples and configurations of communication device are possible.

### Example Clauses

Implementation examples are described in the following numbered clauses:

Clause 1: A method for wireless communications by a user equipment (UE), comprising: receiving MAC CE signaling activating one or more TCI codepoints, wherein each of the TCI codepoints maps to one or more TCI states configured for the UE, wherein each of the TCI states is separately applicable to an uplink transmission or a downlink transmission or jointly applicable to both uplink and downlink transmissions; receiving a first DCI indicating a first TCI codepoint from the activated TCI codepoints; receiving a second DCI scheduling an uplink transmission from the UE or a downlink transmission to the UE, the second DCI conveying panel switching information to the UE; and processing the scheduled uplink transmission or downlink transmission based on one or more TCI states mapped to the first TCI codepoint and the panel switching information.

Clause 2: The method of Clause 1, wherein: the second DCI schedules the downlink transmission to the UE and the first TCI codepoint is mapped to one or more downlink TCI states.

Clause 3: The method of Clause 2, wherein: the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

Clause 4: The method of Clause 3, further comprising: receiving a third DCI indicating a second TCI codepoint from the activated TCI codepoints; receiving a fourth DCI scheduling an uplink transmission from the UE; transmitting the uplink transmission scheduled by the fourth DCI based on one or more TCI states mapped to the second TCI codepoint and the panel switching information conveyed via at least one of the third or fourth DCI.

Clause 5: The method of Clause 4, wherein: the panel switching information comprises one or more dynamic switching bits indicated in the fourth DCI.

Clause 6: The method of any one of Clauses 1-5, wherein: the second DCI schedules the uplink transmission from the UE and the first TCI codepoint is mapped to a pair of uplink TCI states.

Clause 7: The method of Clause 6, wherein: the panel switching information comprises one or more dynamic switching bits indicated in the second DCI.

Clause 8: The method of any one of Clauses 1-7, wherein: the first TCI codepoint maps to one or more joint TCI states, wherein each joint TCI state is applicable to uplink and downlink transmissions.

Clause 9: The method of Clause 8, wherein: the panel switching information is indicated by the first TCI codepoint, and the panel switching information indicates multi-TRP reception or transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state.

Clause 10: The method of Clause 8, wherein: the first TCI codepoint maps to a pair of joint TCI states.

Clause 11: The method of Clause 10, wherein: the panel switching information is conveyed by dynamic switching bits in the second DCI for both downlink and uplink transmissions.

Clause 12: A method for activation and indication of TCI codepoints and panel switching information is described. One or more aspects of the method include transmitting, to a UE, MAC CE signaling activating one or more TCI codepoints configured therein, wherein each of the TCI codepoints maps to one or more TCI states configured for the UE, and wherein each of the TCI states is separately applicable to an uplink transmission or a downlink transmission or jointly applicable to both uplink and downlink transmissions, transmitting, to the UE, a first DCI indicating a first TCI codepoint from the activated TCI codepoints, transmitting, to the UE, a second DCI scheduling an uplink transmission from the UE or a downlink transmission to the UE, the second DCI conveying panel switching information to the UE, and processing the scheduled uplink transmission or downlink transmission based on one or more TCI states mapped to the first TCI codepoint and the panel switching information.

Clause 13: The method of Clause 12, wherein: the second DCI schedules the downlink transmission to the UE and the first TCI codepoint is mapped to one or more downlink TCI states.

Clause 14: The method of Clause 13, wherein: the panel switching information is indicated by the first TCI codepoint, and the panel switching information indicates multi-TRP reception or multi-panel reception if the first TCI codepoint is mapped to a pair of downlink TCI states or the panel switching information indicates single-TRP reception or single-panel reception if the first TCI codepoint is mapped to a single downlink TCI state.

Clause 15: The method of Clause 14, further comprising: transmitting, to the UE, a third DCI indicating a second TCI codepoint from the activated TCI codepoints; transmitting, to the UE, a fourth DCI scheduling an uplink transmission from the UE; receiving, from the UE, the uplink transmission scheduled by the fourth DCI based on one or more TCI states mapped to the second TCI codepoint and the panel switching information conveyed via at least one of the third or fourth DCI.

Clause 16: The method of Clause 15, wherein: the panel switching information comprises one or more dynamic switching bits indicated in the fourth DCI.

Clause 17: The method of any one of Clauses 12-16, wherein: the second DCI schedules the uplink transmission from the UE and the first TCI codepoint is mapped to a pair of uplink TCI states.

Clause 18: The method of Clause 17, wherein: the panel switching information comprises one or more dynamic switching bits indicated in the second DCI.

Clause 19: The method of any one of Clauses 12-18, wherein: the first TCI codepoint maps to one or more joint TCI states, wherein each joint TCI state is applicable to uplink and downlink transmissions.

Clause 20: The method of Clause 19, wherein: the panel switching information is indicated by the first TCI codepoint, and the panel switching information indicates multi-TRP reception transmission or multi-panel reception or transmission if the first TCI codepoint is mapped to a pair of downlink TCI states; or the panel switching information indicates single-TRP reception or transmission or single-panel reception or transmission if the first TCI codepoint is mapped to a single downlink TCI state.

Clause 21: The method of Clause 19, wherein: the first TCI codepoint maps to a pair of joint TCI states.

Clause 22: The method of Clause 21, wherein: the panel switching information is conveyed by dynamic switching bits in the second DCI for both downlink and uplink transmissions.

Clause 23: A processing system, comprising: a memory comprising computer-executable instructions; one or more processors configured to execute the computer-executable instructions and cause the processing system to perform a method in accordance with any one of Clauses 1-22.

Clause 24: A processing system, comprising means for performing a method in accordance with any one of Clauses 1-22.

Clause 25: A non-transitory computer-readable medium comprising computer-executable instructions that, when executed by one or more processors of a processing system, cause the processing system to perform a method in accordance with any one of Clauses 1-22.

Clause 26: A computer program product embodied on a computer-readable storage medium comprising code for performing a method in accordance with any one of Clauses 1-22.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where Dis DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of [SHORT INVENTION DESCRIPTION] in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
receiving media access control (MAC) control element (CE) signaling activating one or more transmission configuration indicator (TCI) codepoints, wherein each of the TCI codepoints maps to one or more TCI states configured for the UE, wherein each of the TCI states is separately applicable to an uplink transmission or a downlink transmission or jointly applicable to both uplink and downlink transmissions;
receiving a first downlink control information (DCI) indicating a first TCI codepoint from the activated TCI codepoints;
receiving a second DCI scheduling an uplink transmission from the UE or a downlink transmission to the UE, the second DCI conveying panel switching information to the UE; and
processing the scheduled uplink transmission or downlink transmission based on one or more TCI states mapped to the first TCI codepoint and the panel switching information.

2. The method of claim 1, wherein:
the second DCI schedules the downlink transmission to the UE; and
the first TCI codepoint is mapped to one or more downlink TCI states.

3. The method of claim 2, wherein the panel switching information is indicated by the first TCI codepoint and:
the panel switching information indicates multi-transmitter receiver point (TRP) reception or multi-panel reception if the first TCI codepoint is mapped to a pair of downlink TCI states; or
the panel switching information indicates single-TRP reception or single-panel reception if the first TCI codepoint is mapped to a single downlink TCI state.

4. The method of claim 3, further comprising:
receiving a third DCI indicating a second TCI codepoint from the activated TCI codepoints;
receiving a fourth DCI scheduling an uplink transmission from the UE; and
transmitting the uplink transmission scheduled by the fourth DCI based on one or more TCI states mapped to the second TCI codepoint and the panel switching information conveyed via at least one of the third or fourth DCI.

5. The method of claim 4, wherein the panel switching information comprises one or more dynamic switching bits indicated in the fourth DCI.

6. The method of claim 1, wherein:
the second DCI schedules the uplink transmission from the UE; and
the first TCI codepoint is mapped to a pair of uplink TCI states.

7. The method of claim 6, wherein the panel switching information comprises one or more dynamic switching bits indicated in the second DCI.

8. The method of claim 1, wherein the first TCI codepoint maps to one or more joint TCI states, wherein each joint TCI state is applicable to uplink and downlink transmissions.

9. The method of claim 8, wherein the panel switching information is indicated by the first TCI codepoint and:
the panel switching information indicates multi-transmitter receiver point (TRP) reception transmission or multi-panel reception or transmission if the first TCI codepoint is mapped to a pair of downlink TCI states; or
the panel switching information indicates single-TRP reception or transmission or single-panel reception or transmission if the first TCI codepoint is mapped to a single downlink TCI state.

10. The method of claim 8, wherein the first TCI codepoint maps to a pair of joint TCI states.

11. The method of claim 10, wherein the panel switching information is conveyed by dynamic switching bits in the second DCI for both downlink and uplink transmissions.

12. A method for wireless communications, comprising:
transmitting, to a user equipment (UE), media access control (MAC) control element (CE) signaling activating one or more transmission configuration indicator (TCI) codepoints configured therein, wherein each of the TCI codepoints maps to one or more TCI states configured for the UE, and wherein each of the TCI states is separately applicable to an uplink transmission or a downlink transmission or jointly applicable to both uplink and downlink transmissions;
transmitting, to the UE, a first downlink control information (DCI) indicating a first TCI codepoint from the activated TCI codepoints;
transmitting, to the UE, a second DCI scheduling an uplink transmission from the UE or a downlink transmission to the UE, the second DCI conveying panel switching information to the UE; and
processing the scheduled uplink transmission or downlink transmission based on one or more TCI states mapped to the first TCI codepoint and the panel switching information.

13. The method of claim 12, wherein:
the second DCI schedules the downlink transmission to the UE; and
the first TCI codepoint is mapped to one or more downlink TCI states.

14. The method of claim 13, wherein the panel switching information is indicated by the first TCI codepoint and:
the panel switching information indicates multi-transmitter receiver point (TRP) reception or multi-panel reception if the first TCI codepoint is mapped to a pair of downlink TCI states; or
the panel switching information indicates single-TRP reception or single-panel reception if the first TCI codepoint is mapped to a single downlink TCI state.

15. The method of claim 14, further comprising:
transmitting, to the UE, a third DCI indicating a second TCI codepoint from the activated TCI codepoints;
transmitting, to the UE, a fourth DCI scheduling an uplink transmission from the UE; and
receiving, from the UE, the uplink transmission scheduled by the fourth DCI based on one or more TCI states mapped to the second TCI codepoint and the panel switching information conveyed via at least one of the third or fourth DCI.

16. The method of claim 15, wherein the panel switching information comprises one or more dynamic switching bits indicated in the fourth DCI.

17. The method of claim 12, wherein:
the second DCI schedules the uplink transmission from the UE; and
the first TCI codepoint is mapped to a pair of uplink TCI states.

18. The method of claim 17, wherein the panel switching information comprises one or more dynamic switching bits indicated in the second DCI.

19. The method of claim 12, wherein the first TCI codepoint maps to one or more joint TCI states, wherein each joint TCI state is applicable to uplink and downlink transmissions.

20. The method of claim 19, wherein the panel switching information is indicated by the first TCI codepoint and:
the panel switching information indicates multi-transmitter receiver point (TRP) reception transmission or multi-panel reception or transmission if the first TCI codepoint is mapped to a pair of downlink TCI states; or
the panel switching information indicates single-TRP reception or transmission or single-panel reception or transmission if the first TCI codepoint is mapped to a single downlink TCI state.

21. The method of claim 19, wherein the first TCI codepoint maps to a pair of joint TCI states.

22. The method of claim 21, wherein the panel switching information is conveyed by dynamic switching bits in the second DCI for both downlink and uplink transmissions.

23. A user equipment (UE), comprising:
at least one memory; and
at least one processor coupled to the memory, the memory and the processor configured to:
receive media access control (MAC) control element (CE) signaling activating one or more transmission configuration indicator (TCI) codepoints, wherein each of the TCI codepoints maps to one or more TCI states configured for the UE, wherein each of the TCI states is separately applicable to an uplink transmission or a downlink transmission or jointly applicable to both uplink and downlink transmissions;
receive a first downlink control information (DCI) indicating a first TCI codepoint from the activated TCI codepoints;
receive a second DCI scheduling an uplink transmission from the UE or a downlink transmission to the UE, the second DCI conveying panel switching information to the UE; and
process the scheduled uplink transmission or downlink transmission based on one or more TCI states mapped to the first TCI codepoint and the panel switching information.

24. A non-transitory computer-readable medium comprising computer-executable instructions that, when executed by one or more processors of a user equipment (UE), cause the UE to:
receive media access control (MAC) control element (CE) signaling activating one or more transmission configuration indicator (TCI) codepoints, wherein each of the TCI codepoints maps to one or more TCI states configured for the UE, wherein each of the TCI states is separately applicable to an uplink transmission or a downlink transmission or jointly applicable to both uplink and downlink transmissions;
receive a first downlink control information (DCI) indicating a first TCI codepoint from the activated TCI codepoints;
receive a second DCI scheduling an uplink transmission from the UE or a downlink transmission to the UE, the second DCI conveying panel switching information to the UE; and
process the scheduled uplink transmission or downlink transmission based on one or more TCI states mapped to the first TCI codepoint and the panel switching information.

25. An apparatus, comprising:
at least one memory; and
at least one processor coupled to the memory, the memory and the processor configured to cause the apparatus to:
transmit, to a user equipment (UE), media access control (MAC) control element (CE) signaling activating one or more transmission configuration indicator (TCI) codepoints configured therein, wherein each of the TCI codepoints maps to one or more TCI states configured for the UE, and wherein each of the TCI states is separately applicable to an uplink transmission or a downlink transmission or jointly applicable to both uplink and downlink transmissions;
transmit, to the UE, a first downlink control information (DCI) indicating a first TCI codepoint from the activated TCI codepoints;
transmit, to the UE, a second DCI scheduling an uplink transmission from the UE or a downlink transmission to the UE, the second DCI conveying panel switching information to the UE; and
process the scheduled uplink transmission or downlink transmission based on one or more TCI states mapped to the first TCI codepoint and the panel switching information.
